(19) United States
(12) Patent Application Publication
(10) Pub. No.: US 2008/0082532 A1
(43) Pub. Date: Apr. 3, 2008

(54) Using Counter-Flip Acknowledge And Memory-Barrier Shoot-Down To Simplify Implementation of Read-Copy Update In Realtime Systems

(75) Inventor: Paul E. McKenney, Beaverton, OR (US)

Correspondence Address: WALTER W. DUFT, 8616 MAIN STREET, SUITE 2, WILLIAMSVILLE, NY, 14221, US

(73) Assignee: INTERNATIONAL BUSINESS MACHINES CORPORATION, Armonk, NY (US)

(21) Appl. No.: 11/538,241

(22) Filed: Oct. 3, 2006

(51) Int. Cl. G06F 17/30

(52) U.S. Cl. 707/8

(57) ABSTRACT

A technique for realtime-safe detection of a grace period for deferring the destruction of a shared data element until pre-existing references to the data element have been removed. A grace period identifier is provided for readers of the shared data element to consult. A next grace period is initiated by manipulating the grace period identifier, and an acknowledgement thereof is requested from processing entities capable of executing the readers before detecting when a current grace period has ended. Optionally, when the end of the current grace period is determined, arrangement is made for a memory barrier shoot-down on processing entities capable of executing the readers. Data destruction operations to destroy the shared data element are then deferred until it is determined that the memory barriers have been implemented. Data destruction operations may be further deferred until two consecutive grace periods have expired.

### BACKGROUND OF THE INVENTION

1. Field of the Invention

The present invention relates to computer systems and methods in which data resources are shared among concurrent data consumers while preserving data integrity and consistency relative to each consumer. More particularly, the invention concerns an implementation of a mutual exclusion mechanism known as “read-copy update” in a preemptive real-time computing environment.

2. Description of the Prior Art

By way of background, read-copy update is a mutual exclusion technique that permits shared data to be accessed for reading without the use of locks, writes to shared memory, memory barriers, atomic instructions, or other computationally expensive synchronization mechanisms, while still permitting the data to be updated (modify, delete, insert, etc.) concurrently. The technique is well suited to multiprocessor computing environments in which the number of read operations (readers) accessing a shared data set is large in comparison to the number of update operations (updaters), and wherein the overhead cost of employing other mutual exclusion techniques (such as locks) for each read operation would be high. By way of example, a network routing table that is updated at most once every few minutes but searched many thousands of times per second is a case where read-side lock acquisition would be quite burdensome.

The read-copy update technique implements data updates in two phases. In the first (initial update) phase, the actual data update is carried out in a manner that temporarily preserves two views of the data being updated. One view is the old (pre-update) data state that is maintained for the benefit of operations that may be currently referencing the data. The other view is the new (post-update) data state that is available for the benefit of operations that access the data following the update. In the second (deferred update) phase, the old data state is removed following a “grace period” that is long enough to ensure that all executing operations will no longer maintain references to the pre-update data.

FIGS. 1A-1D illustrate the use of read-copy update to modify a data element B in a group of data elements A, B and C. The data elements A, B, and C are arranged in a singly-linked list that is traversed in acyclic fashion, with each element containing a pointer to a next element in the list (or a NULL pointer for the last element) in addition to storing some item of data. A global pointer (not shown) is assumed to point to data element A, the first member of the list. Persons skilled in the art will appreciate that the data elements A, B and C can be implemented using any of a variety of conventional programming constructs, including but not limited to, data structures defined by C-language “struct” variables.

It is assumed that the data element list of FIGS. 1A-1D is traversed (without locking) by multiple concurrent readers and occasionally updated by updaters that delete, insert or modify data elements in the list. In FIG. 1A, the data element B is being referenced by a reader r1, as shown by the vertical arrow below the data element. In FIG. 1B, an updater u1 wishes to update the linked list by modifying data element B. Instead of simply updating this data element without regard to the fact that r1 is referencing it (which might crash r1), u1 preserves B while generating an updated version thereof (shown in FIG. 1C as data element B′) and inserting it into the linked list. This is done by u1 acquiring an appropriate lock, allocating new memory for B′, copying the contents of B to B′, modifying B′ as needed, updating the pointer from A to B so that it points to B′, and releasing the lock. As an alternative to locking, other techniques such as non-blocking synchronization or a designated update thread could be used to serialize data updates. All subsequent (post update) readers that traverse the linked list, such as the reader r2, will see the effect of the update operation by encountering B′. On the other hand, the old reader r1 will be unaffected because the original version of B and its pointer to C are retained. Although r1 will now be reading stale data, there are many cases where this can be tolerated, such as when data elements track the state of components external to the computer system (e.g., network connectivity) and must tolerate old data because of communication delays.

At some subsequent time following the update, r1 will have continued its traversal of the linked list and moved its reference off of B. In addition, there will be a time at which no other reader process is entitled to access B. It is at this point, representing expiration of the grace period referred to above, that u1 can free B, as shown in FIG. 1D.

FIGS. 2A-2C illustrate the use of read-copy update to delete a data element B in a singly-linked list of data elements A, B and C. As shown in FIG. 2A, a reader r1 is assumed be currently referencing B and an updater u1 wishes to delete B. As shown in FIG. 2B, the updater u1 updates the pointer from A to B so that A now points to C. In this way, r1 is not disturbed but a subsequent reader r2 sees the effect of the deletion. As shown in FIG. 2C, r1 will subsequently move its reference off of B, allowing B to be freed following expiration of the grace period.

In the context of the read-copy update mechanism, a grace period represents the point at which all running processes (or threads within a process) having access to a data element guarded by read-copy update have passed through a “quiescent state” in which they can no longer maintain references to the data element, assert locks thereon, or make any assumptions about data element state. By convention, for operating system kernel code paths, a context (process) switch, an idle loop, and user mode execution all represent quiescent states for any given CPU running non-preemptable code (as can other operations that will not be listed here).

In FIG. 3, four processes 0, 1, 2, and 3 running on four separate CPUs are shown to pass periodically through quiescent states (represented by the double vertical bars). The grace period (shown by the dotted vertical lines) encompasses the time frame in which all four processes have passed through one quiescent state. If the four processes 0, 1, 2, and 3 were reader processes traversing the linked lists of FIGS. 1A-1D or FIGS. 2A-2C, none of these processes having reference to the old data element B prior to the grace period could maintain a reference thereto following the grace period. All post grace period searches conducted by these processes would bypass B by following the links inserted by the updater.

There are various methods that may be used to implement a deferred data update following a grace period, including but not limited to the use of callback processing as described in commonly assigned U.S. Pat. No. 5,442,758, entitled “System And Method For Achieving Reduced Overhead Mutual-Exclusion And Maintaining Coherency In A Multiprocessor System Utilizing Execution History And Thread Monitoring.”

The callback processing technique contemplates that an updater of a shared data element will perform the initial (first phase) data update operation that creates the new view of the data being updated, and then specify a callback function for performing the deferred (second phase) data update operation that removes the old view of the data being updated. The updater will register the callback function (hereinafter referred to as a “callback”) with a read-copy update subsystem (RCU subsystem) so that it can be executed at the end of the grace period. The RCU subsystem keeps track of pending callbacks for each processor and monitors per-processor quiescent state activity in order to detect when each processor's current grace period has expired. As each grace period expires, all scheduled callbacks that are ripe for processing are executed.

Conventional grace period processing faces challenges in a preemptive realtime computing environment because a context switch does not always guarantee that a grace period will have expired. In a preemptive realtime computing system, a reader holding a data reference can be preempted by a higher priority process. Such preemption represents a context switch, but can occur without the usual housekeeping associated with a non-preemptive context switch, such as allowing the existing process to exit a critical section and remove references to shared data. It therefore cannot be assumed that a referenced data object is safe to remove merely because all readers have passed through a context switch. If a reader has been preempted by a higher priority process, the reader may still be in a critical section and require that previously-obtained data references be valid when processor control is returned.

One way to address this problem is to provide fastpath routines that readers can invoke in order to register and deregister with the RCU subsystem prior to and following critical section read-side operations, thereby allowing readers to signal the RCU subsystem when a quiescent state has been reached. The rcu_read_lock( ) and rcu_read_unlock( ) primitives of recent Linux® kernel versions are examples of such routines. The rcu_read_lock( ) primitive is called by a reader immediately prior to entering its read-side critical section. This code assigns the reader to a current or next generation grace period and sets an indicator associated with the assigned grace period (e.g., by incrementing a counter or acquiring a lock) that is not reset until the reader exits the critical section. The indicator(s) set by all readers associated with a particular grace period generation will be periodically tested by a grace period detection component within the RCU subsystem. Callback processing for a given grace period will not commence until the grace period detection component detects a reset condition for all indicator(s) associated with that grace period. The rcu_read_unlock( ) primitive is called by a reader immediately after leaving its critical section. This code resets the indicator set during invocation of the rcu_read_lock( ) primitive (e.g., by decrementing a counter or releasing a lock), thereby signaling to the RCU subsystem that the reader will not be impacted by removal of its critical section read data (i.e., that a quiescent state has been reached), and that callback processing may proceed.

Using reader registration/deregistration, the preemption of a reader while in a read-side critical section will not result in premature callback processing because the RCU subsystem must first wait for each reader assigned to a given grace period to deregister. However, there can be considerable read-side overhead associated with registration/deregistration processing insofar as these operations conventionally use memory barriers to synchronize memory accesses in hardware environments employing weak memory consistency models. Moreover, if the indicators manipulated by the registration and deregistration operations are counters, atomic instructions are used to increment and decrement the counters. Furthermore, a check must be made after counter manipulation to determine that the counter associated with the correct grace period was used, and if not, a different counter must be manipulated.

It is to solving the foregoing problems that the present invention is directed. In particular, what is required is a read-copy update technique that may be safely used in a preemptive realtime computing environment while minimizing the read-side overhead needed to maintain memory ordering between readers and the grace period detection mechanism. These requirements will preferably be met in a manner that avoids excessive complexity of the grace period detection mechanism itself.

### SUMMARY OF THE INVENTION

The foregoing problems are solved and an advance in the art is obtained by a method, system and computer program product for implementing realtime-safe detection of a grace period for deferring the destruction of a shared data element until pre-existing references to the data element are removed. A grace period identifier is provided for readers of the shared data element to consult. A next grace period is initiated by manipulating the grace period identifier, and an acknowledgement thereof is requested from processing entities capable of executing the readers before detecting when a current grace period has ended.

In a further aspect, when the end of the current grace period is determined, arrangement is made for a memory barrier shoot-down on processing entities capable of executing the readers. Data destruction operations to destroy the shared data element are then deferred until it is determined that the memory barriers have been implemented.

In a still further aspect, data destruction operations may be additionally deferred until two consecutive grace periods have expired.

### BRIEF DESCRIPTION OF THE DRAWINGS

The foregoing and other features and advantages of the invention will be apparent from the following more particular description of exemplary embodiments of the invention, as illustrated in the accompanying Drawings, in which:

FIGS. 1A-1D are diagrammatic representations of a linked list of data elements undergoing a data element replacement according to a conventional read-copy update mechanism;

FIGS. 2A-2C are diagrammatic representations of a linked list of data elements undergoing a data element deletion according to a conventional read-copy update mechanism;

FIG. 3 is a flow diagram illustrating a grace period in which four processes pass through a quiescent state;

FIG. 4 is a functional block diagram showing a multiprocessor computing system that represents an exemplary environment for implementing grace period detection processing in accordance with the disclosure herein;

FIG. 5 is a functional block diagram showing a read-copy update subsystem implemented by each processor in the multiprocessor computer system of FIG. 4;

FIG. 6 is a table showing grace period detection information associated with the processors of the multiprocessor computer system of FIG. 4;

FIG. 7 is a functional block diagram showing a cache memory containing grace period detection information for a single processor;

FIG. 8 is a state diagram showing operational states that may be assumed during grace period detection processing; and

FIG. 9 is a diagrammatic illustration showing media that may be used to provide a computer program product for implementing grace period detection processing in accordance with the disclosure herein.

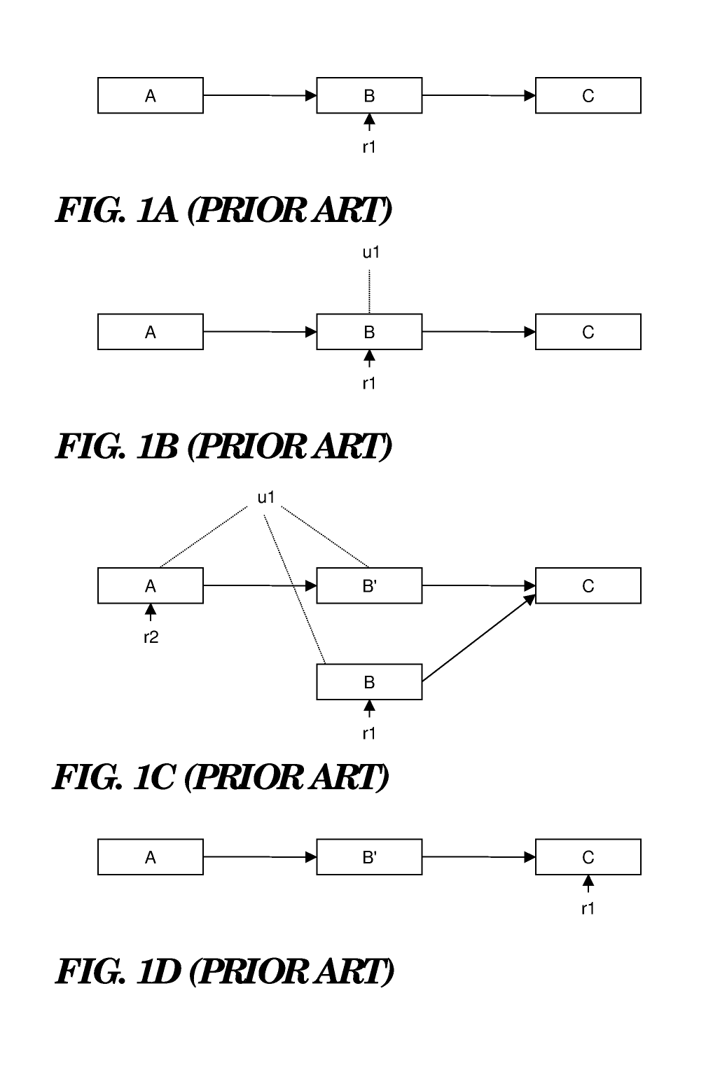

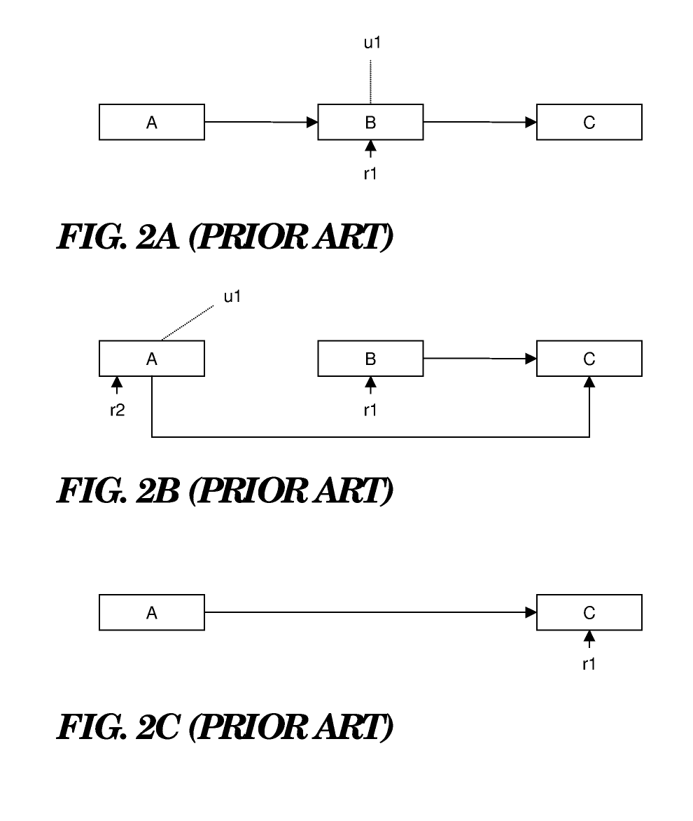

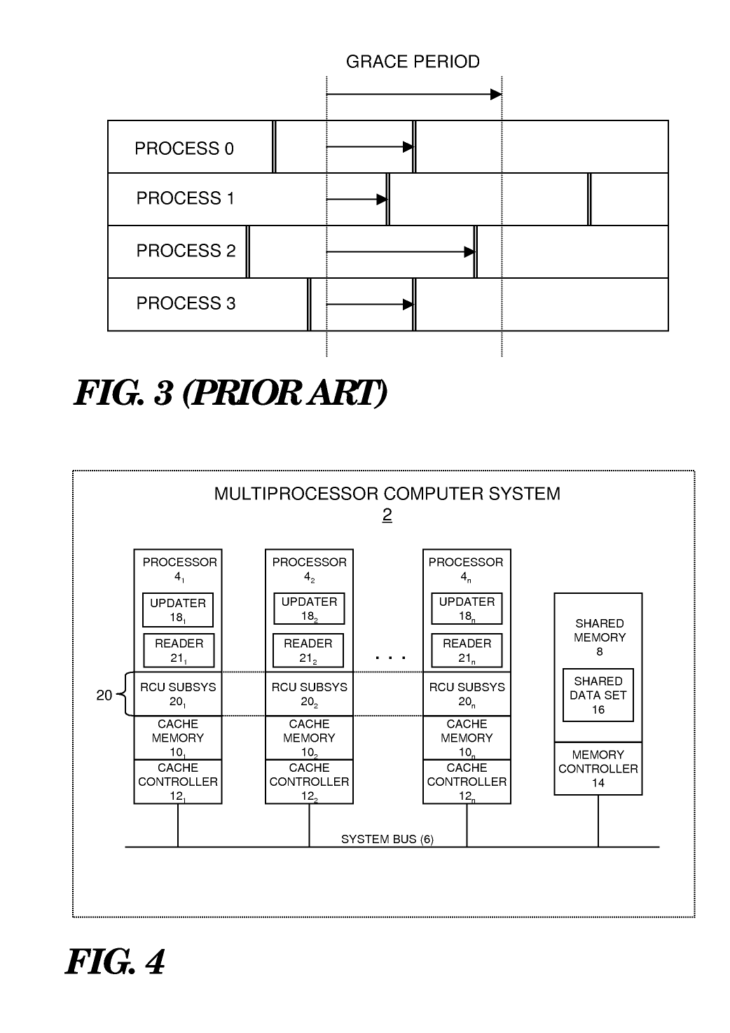

### DETAILED DESCRIPTION OF EXEMPLARY EMBODIMENTS

Turning now to the figures, wherein like reference numerals represent like elements in all of the several views, FIG. 4 illustrates an exemplary computing environment in which the present invention may be implemented. In particular, a symmetrical multiprocessor (SMP) computing system 2 is shown in which multiple processors 4₁, 4₂ . . . 4ₙ are connected by way of a common system bus 6 to a shared memory 8. Respectively associated with each processor 4₁, 4₂ . . . 4ₙ is a conventional cache memory 10₁, 10₂ . . . 10ₙ and a cache controller 12₁, 12₂ . . . 12ₙ. A conventional memory controller 14 is associated with the shared memory 8. The computing system 2 is assumed to be under the management of a single multitasking operating system adapted for use in an SMP environment. In the alternative, a single processor computing environment could be used to implement the invention.

It is further assumed that update operations executed within kernel or user mode processes, threads, or other execution contexts will periodically perform updates on a set of shared data 16 stored in the shared memory 8. Reference numerals 18₁, 18₂ . . . 18ₙ illustrate individual data update operations (updaters) that may periodically execute on the several processors 4₁, 4₂ . . . 4ₙ. As described by way of background above, the updates performed by the data updaters 18₁, 18₂ . . . 18ₙ can include modifying elements of a linked list, inserting new elements into the list, deleting elements from the list, and many other types of operations. To facilitate such updates, the several processors 4₁, 4₂ . . . 4ₙ are programmed to implement a read-copy update (RCU) subsystem 20, as by periodically executing respective RCU instances 20₁, 20₂ . . . 20ₙ as part of their operating system functions. Each of the processors 4₁, 4₂ . . . 4ₙ also periodically executes read operations (readers) 21₁, 21₂ . . . 21ₙ on the shared data 16. Such read operations will typically be performed far more often than updates, insofar as this is one of the premises underlying the use of read-copy update.

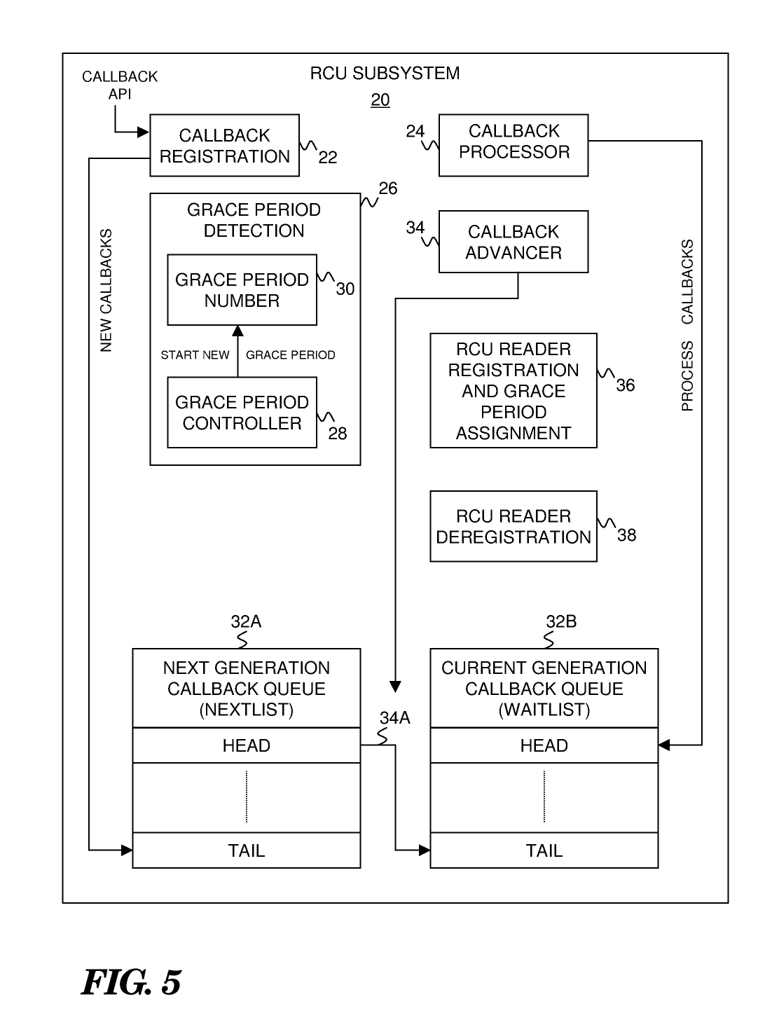

As shown in FIG. 5, the RCU subsystem 20 includes a callback registration component 22. The callback registration component 22 serves as an API (Application Program Interface) to the RCU subsystem 20 that can be called by the updaters 18₂ . . . 18ₙ to register requests for deferred (second phase) data element updates following initial (first phase) updates performed by the updaters themselves. As is known in the art, these deferred update requests involve the destruction of stale data elements, and will be handled as callbacks within the RCU subsystem 20. A callback processing component 24 within the RCU subsystem 20 is responsible for executing the callbacks, then removing the callbacks as they are processed. A grace period detection component 26 determines when a current grace period has expired so that the callback processor 24 can execute callbacks associated with the current grace period generation. In a preemptive multitasking environment, the grace period detection component 26 includes a grace period controller 28 that keeps track of a grace period number 30. Advancement of the grace period number 30 signifies that a next grace period should be started and that detection of the end of the current grace period may be initiated.

The read-copy update subsystem 20 also implements a mechanism for batching callbacks for processing by the callback processor 24 at the end of each grace period. One exemplary batching technique is to maintain a set of callback queues 32A and 32B that are manipulated by a callback advancer 34. Although the callback queues 32A/32B can be implemented using a shared global array that tracks callbacks registered by each of the updaters 18₁, 18₂ . . . 18ₙ, improved scalability can be obtained if each read-copy update subsystem instance 20₁, 20₂ . . . 20ₙ maintains its own pair of callback queues 32A/32B in a corresponding one of the cache memories 10₁, 10₂ . . . 10ₙ. Maintaining per-processor versions of the callback queues 32A/32B in the local caches 10₁, 10₂ . . . 10ₙ reduces memory latency. Regardless of which implementation is used, the callback queue 32A, referred to as the “Next Generation” or “Nextlist” queue, can be appended (or prepended) with new callbacks by the callback registration component 22 as such callbacks are registered. The callbacks registered on the callback queue 32A will not become eligible for grace period processing until the end of the next grace period that follows the current grace period. The callback queue 32B, referred to as the “Current Generation” or “Waitlist” queue, maintains the callbacks that are eligible for processing at the end of the current grace period. The callback processor 24 is responsible for executing the callbacks referenced on the Current Generation callback queue 32B, and for removing the callbacks therefrom as they are processed. The callback advancer 34 is responsible for moving the callbacks on the Next Generation callback queue 32A to the Current Generation callback queue 32B after a subsequent grace period is started. The arrow labeled 34A in FIG. 5 illustrates this operation.

The reason why new callbacks are not eligible for processing and cannot be placed on the Current Generation callback queue 32B becomes apparent if it is recalled that a grace period represents a time frame in which all processors have passed through at least one quiescent state. If a callback has been pending since the beginning of a grace period, it is guaranteed that no processor will maintain a reference to the data element associated with the callback at the end of the grace period. On the other hand, if a callback was registered after the beginning of the current grace period, there is no guarantee that all processors potentially affected by this callback's update operation will have passed through a quiescent state.

In non-realtime computing environments, grace period detection can be conventionally based on each of the processors 4₁, 4₂ . . . 4ₙ passing through a quiescent state that typically arises from a context switch. However, as described by way of background above, if the processors 4₁, 4₂ . . . 4ₙ are programmed to run a preemptable realtime operating system, an executing process or thread (each of which may also be referred to as a “task”), such as any of the readers 21₁, 21₂ . . . 21ₙ, can be preempted by a higher priority process. Such preemption can occur even while the readers 21₁, 21₂ . . . 21ₙ are in a kernel mode critical section referencing elements of the shared data set 16 (shared data elements). In order to prevent premature grace period detection and callback processing, a technique is needed whereby the readers 21₁, 21₂ . . . 21ₙ can advise the RCU subsystem 20 that they are performing critical section processing.

Although one solution would be to suppress preemption across read-side critical sections, this approach can degrade realtime response latency. As described by way of background above, a more preferred approach is to have readers “register” with the RCU subsystem 20 whenever they enter a critical section and “deregister” upon leaving the critical section, thereby signaling the RCU subsystem 20 that a quiescent state has been reached. To that end, the RCU subsystem 20 is provided with two fast-path routines that the readers 21₁, 21₂ . . . 21ₙ can invoke in order to register and deregister with the RCU subsystem prior to and following critical section read-side operations. In FIG. 5, reference numeral 36 represents an RCU reader registration component that may be implemented using code such as the Linux® Kernel rcu_read_lock( ) primitive. Reference numeral 38 represents an RCU reader deregistration component that may be implemented using code such as the Linux® Kernel rcu_read_unlock( ) primitive. The registration component 36 is called by a reader 21₁, 21₂ . . . 21ₙ immediately prior to entering its read-side critical section. This code registers the reader 21₁, 21₂ . . . 21ₙ with the RCU subsystem 20 by assigning the reader to either a current or next generation grace period and by setting an indicator (e.g., incrementing a counter or acquiring a lock) that is not reset until the reader exits the critical section. The grace period indicators for each reader 21₁, 21₂ . . . 21ₙ assigned to a particular grace period generation are periodically tested by the grace period controller 28 and the grace period will not be ended until all of the indicators have been reset. The deregistration component 38 is called by a reader 21₁, 21₂ . . . 21ₙ immediately after leaving its critical section. This code deregisters the reader 21₁, 21₂ . . . 21ₙ from the RCU subsystem 20 by resetting the indicator set during invocation of the registration component 32, thereby signifying that the reader will not be impacted by removal of its critical section read data (i.e., that a quiescent state has been reached), and that the grace period may be ended.

Various techniques may be used to implement the registration and deregistration components 36 and 38. For example, commonly assigned application Ser. No. 11/248,096 discloses a design in which RCU reader registration/deregistration is implemented using per-processor counter pairs. One counter of each counter pair is used for a current grace period generation and the other counter is used for a next grace period generation. When a reader 21₁, 21₂ . . . 21ₙ registers for RCU read-side processing, it increments the counter that corresponds to the grace period number 30, whose lowest order bit serves as a Boolean counter selector or “flipper” that determines which counter should be used. Grace period advancement and callback processing to remove the reader's read-side data will not be performed until the grace period detection component 26 determines that the reader has deregistered by decrementing the previously-incremented counter. Commonly assigned application Ser. No. 11/264,580 discloses an alternative design for implementing RCU reader registration/deregistration using reader/writer locks. In particular, when a reader registers for read-side processing, it acquires a reader/writer lock. Grace period advancement and callback processing to remove the reader's read-side data will not be performed until the reader deregisters and releases the reader/writer lock. In order to start a new grace period and process callbacks, the writer portion of each reader/writer lock must be acquired.

When reader registration/deregistration is used, preemption of a reader 21₁, 21₂ . . . 21ₙ while in a read-side critical section will not result in premature callback processing because the RCU subsystem 20 must wait for each reader to deregister and thereby enter a quiescent state. However, as stated by way of background above, there is read-side overhead resulting from the need to maintain memory ordering between the readers 21₁, 21₂ . . . 21ₙ and the grace period detection component 26. For example, in previous implementations of the registration component 36 (based on counters), a memory barrier has been implemented after incrementing the counter associated with the current grace period. This memory barrier prevents the contents of a reader's critical section from “bleeding out” into earlier code as a result of the counter increment appearing on other processors processor 4₁, 4₂ . . . 4ₙ as having been performed after the reader's critical section has commenced on the reader's processor. If the reader's processor 4₁, 4₂ . . . 4ₙ is capable of executing instructions and memory references out of order, failure to implement this memory barrier would allow the reader 21₁, 21₂ . . . 21ₙ to acquire a pointer to a critical section data structure, then have the registration component 36 increment the wrong counter if its execution is deferred until after a new grace period has started. This could result in the reader failing to protect its earlier pointer fetch if the grace period detection component 26 is monitoring a different counter to determine when it is safe to process callbacks.

Another memory barrier has been implemented in previous versions of the deregistration component 38 (based on counters) after decrementing a previously-incremented counter to signify that the current grace period may be ended. This memory barrier prevents a reader's critical section from “bleeding out” into subsequent code as a result of the counter decrement appearing on other processors processor 4₁, 4₂ . . . 4ₙ as having been performed before the reader's critical section has completed on the reader's processor. If the reader's processor 4₁, 4₂ . . . 4ₙ is capable of executing instructions and memory references out of order, failure to implement this memory barrier could result in the counter being treated as decremented before the reader 21₁, 21₂ . . . 21ₙ has actually completed critical section processing, possibly resulting in premature callback processing.

Current registration/deregistration processing, if based on the use of counters, also utilizes atomic instructions to increment and decrement the counters. These expensive instructions are needed in order to prevent races between readers 21₁, 21₂ . . . 21ₙ on different processors 4₁, 4₂ . . . 4ₙ attempting to manipulate the same counter. Typically, there are a pair of counters associated with each processor 4₁, 4₂ . . . 4ₙ. One counter is for the current grace period and the other counter is for the previous grace period. A reader's registration component 36 will increment a given counter associated with the processor on which it runs (which may be referred to generically as CPU 0). The reader's deregistration component 38 will thereafter decrement the same counter. However, if the reader 21₁, 21₂ . . . 21ₙ was preempted during critical section processing, the deregistration component 38 may be invoked on a different processor (which may be referred to generically as CPU 1). If the deregistration component 38 on CPU 1 attempts to decrement CPU 0's counter at the same time that another reader's registration component 38 is attempting to increment the same counter on CPU 0, a conflict could occur. This conflict is avoided if the counters are incremented and decremented using atomic instructions. Like memory barriers, such instructions are relatively “heavy weight” and it would be desirable to remove them from the reader registration and deregistration components 36 and 38.

An additional aspect of prior versions of the registration components 36 and 38 is that a check must be made after counter manipulation to determine that the counter associated with the correct grace period was used, and if not, a different counter must be manipulated. This check is needed to avoid a race condition with the grace period detection component 26, which might initiate a new grace period between the time that the counter index is obtained and the counter manipulation occurs, thus resulting in the wrong counter being manipulated. Moreover, in the registration component 36, there could be an indefinite delay between counter index acquisition and counter incrementation (e.g., due to correctable ECC errors in memory or cache). This could result in the grace period detection component 26 not seeing the registration component's counter incrementation in time to prevent callback processing.

The foregoing read-side overhead may be eliminated by modifying the registration component 36 and the deregistration component 38 to remove memory barrier instructions, atomic instructions and counter checks such as those described above. Memory ordering may then be maintained between the readers 21₁, 21₂ . . . 21ₙ and the grace period detection component 26 by modifying the latter in a manner that ensures proper grace period detection without unduly increasing the complexity of such operations. As described in more detail below, the modified grace period detection component 26 may implement grace period processing according to the instruction execution and memory reference state of the processors 4₁, 4₂ . . . 4ₙ implementing the readers 21₁, 21₂ . . . 21ₙ.

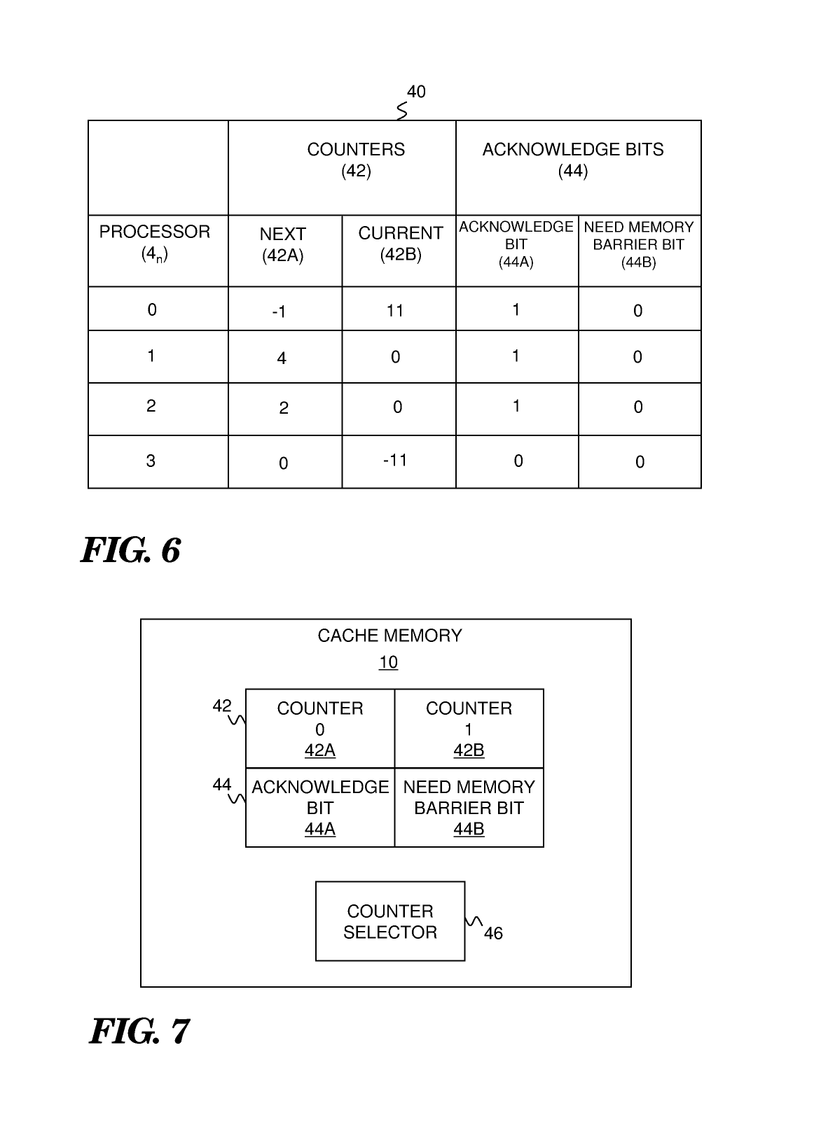

Turning now to FIG. 6, a table 40 illustrates data that may be used for grace period detection according to an exemplary implementation wherein per-processor counter pairs are provided for registration/deregistration operations. As additionally shown in FIG. 7, the table 40 represents data that the hardware cache controllers 12₁, 12₂ . . . 12ₙ will typically maintain in the cache memories 10₁, 10₂ . . . 10ₙ of the processors 4₁, 4₂ . . . 4ₙ (identified in table 40 as processors 0, 1, 2, 3). For each of the processors 4₁, 4₂ . . . 4ₙ there are a pair of counters 42 comprising a next counter 42A and a current counter 42B, and a pair of acknowledge bits 44 comprising an individual acknowledge bit 44A and a need-memory-barrier bit 44B.

When a reader 21₁, 21₂ . . . 21ₙ executes on one of the processors 4₁, 4₂ . . . 4ₙ it invokes the registration component 36 prior to performing critical section processing. The registration component 36 accesses the grace period number 30 and performs a bitwise AND operation (using 0×1) to derive a Boolean counter selector (“flipper”) value 46 that is stored in the reader's task structure (typically maintained by the hardware cache controllers 12₁, 12₂ . . . 12ₙ within one of the cache memories 10₁, 10₂ . . . 10ₙ (see FIG. 7)). As previously described, the registration component 36 uses the counter selector 46 to select either the next counter 42A or the current counter 42B of the host processor 4₁, 4₂ . . . 4ₙ on which it is currently running. The selected counter is then incremented and registration terminates. Following critical section processing, the reader 21₁, 21₂ . . . 21ₙ invokes the deregistration component 38 to decrement the counter 42A or 42B associated with the counter selector 46. Because the reader 21₁, 21₂ . . . 21ₙ may not be running on the same processor 4₁, 4₂ . . . 4ₙ that it ran on during registration, the decremented counter 42A or 42B will not necessarily be the same one that was incremented during registration. Unlike prior read-copy update implementations, the deregisration component 38 does not attempt to decrement the counter 42A or 42B on the same processor 4₁, 4₂ . . . 4ₙ that ran the registration component 36. Instead, the counter 42A or 42B being decremented will be associated with the processor 4₁, 4₂ . . . 4ₙ that currently runs the deregistration component 38, which may or may not be the original processor. The need for atomic instructions to manipulate the counters 42A or 42B in the registration and deregistration components 36 and 38 can thus be eliminated insofar as there will only be one piece of code manipulating any given processor's counters at one time.

It may sometimes be the case that the registration component 36 increments a counter 42A or 42B on one processor 4₁, 4₂ . . . 4ₙ while the deregistration component 36 decrements the corresponding counter on a different processor. FIG. 6 reflects this circumstance insofar as the next counter 42A has a count of −1 for processor 0, while the current counter 42B has a count of −11 for processor 3. Had each reader 21₁, 21₂ . . . 21ₙ performed its registration/deregistration operations on the same processor 4₁, 4₂ . . . 4ₙ, there would be no negative counter values. However, negative counter values can be easily handled during grace period processing by having the grace period detection component 26 sum each of the counters (42A or 42B) on all processors 4₁, 4₂ . . . 4ₙ. If the total counter sum is zero, as is the case for the current counters 42B in FIG. 6, it may be safely determined that the associated grace period has ended. All of the readers 21₁, 21₂ . . . 21ₙ will have deregistered (and reached quiescent states) and callbacks for the corresponding grace period may be processed.

The acknowledge bits 44A and the need-memory-barrier bits 44B of the table 40 are used by the grace period detection component 26 to perform grace period detection processing in a manner that frees the registration component 36 and the deregistration component 38 of the need to implement other costly operations. The acknowledge bits 44A are used at the beginning of grace period detection. They free the registration component 36 from having to perform a counter index check following incrementation of one of the counters 42A or 42, and thereafter having to increment the other counter if the grace period detection component 26 advanced a grace period between the acquisition of the counter index and the first counter incrementation. The need-memory-barrier bits 44B are used at the end of grace period detection. They allow memory barriers to be removed from the deregistration component 38.

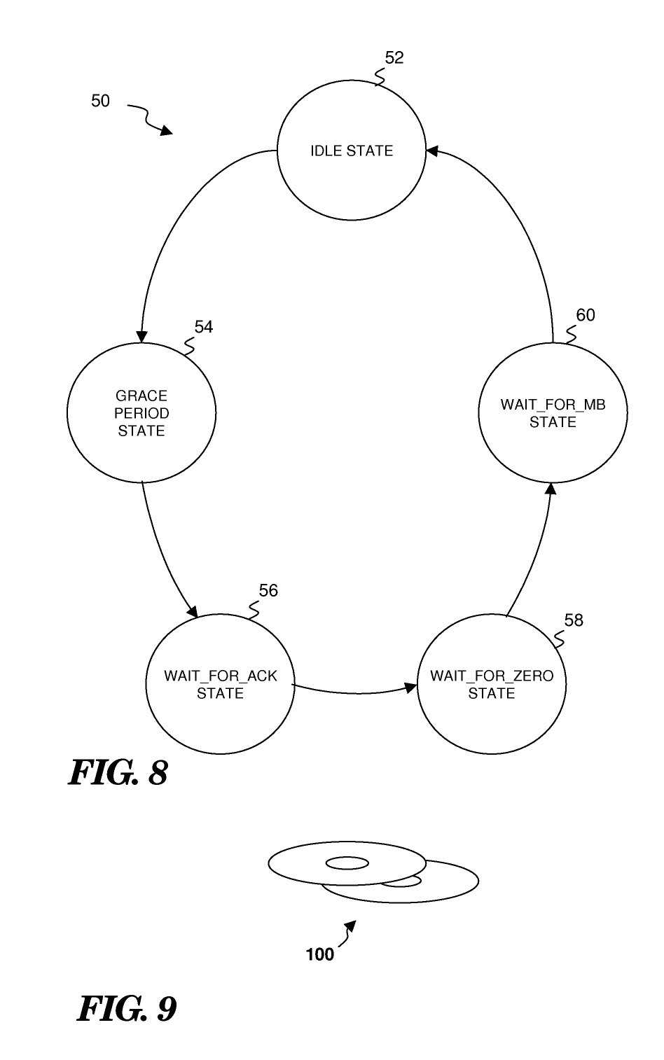

Turning now to FIG. 8, the grace period detection component 26 may implement a state machine 50 that manipulates the acknowledge bits 44A and the need-memory-barrier bits 44B in order to synchronize grace period detection operations with those of the registration component 36 and the deregistration component 38. The state machine 50 may be called periodically in hardware interrupt context (e.g., using scheduling clock interrupts), or alternatively by using explicit interprocessor interrupts (IPIs). Another alternative would be to invoke the state machine 50 periodically from non-interrupt code. This implementation would be useful in out-of-memory situations. For example, a memory allocator or an OOM (Out-Of-Memory) detector might invoke the state machine 50 in order to force a grace period in a timely fashion, so as to free up memory awaiting the grace period.

The state machine 50 begins in an idle state 52 wherein no grace period detection processing is performed until one of the processors 4₁, 4₂ . . . 4ₙ has reason to detect a grace period. Reasons might include a given processor 4₁, 4₂ . . . 4ₙ accumulating a specified number of outstanding callbacks, a processor having had an outstanding callback for longer than a specified time duration, the amount of available free memory decreasing below a specified level, or some combination of the foregoing, perhaps including dynamic computation of specific values. Alternatively, a simple implementation might immediately exit the idle state 52, although this could waste processor cycles unnecessarily detecting unneeded grace periods.

Following the idle state 52, the state machine 50 enters a grace period state 54 in which the grace period detection component 26 initiates detection of the end of the current grace period. This operation begins with incrementing the grace period number 30, which signifies the beginning of the next grace period (and that the counters 42A and 42B have swapped roles or “flipped”). This will result in all outstanding callbacks on the Next Generation callback queue 32A being moved to the Current Generation callback queue 32B. New callbacks will then begin to accumulate on the Next Generation callback queue 32A. Before leaving the grace period state 54, the grace period detection component 26 will also execute an SMP (Symmetrical MultiProcessor) memory barrier instruction and then set the acknowledge bits 44A for all of the processors 4₁, 4₂ . . . 4ₙ. The memory barrier ensures that other processors 4₁, 4₂ . . . 4ₙ will see the new grace period number 30 (or counter “flip”) before they see that the acknowledge bits 44A have been set.

The state machine 50 will next enter a wait_for_ack state 56 in which the grace period detection component 26 waits for all of the processors 4₁, 4₂ . . . 4ₙ to reset their acknowledge bit 44A. The acknowledge bits 44A of the processors 4₁, 4₂ . . . 4ₙ may be checked prior to invocation of the state machine 50 by running an acknowledge bit check routine on each processor 4₁, 4₂ . . . 4ₙ e.g., during handling of the same interrupt that causes the state machine to execute (if the state machine runs in interrupt context). The acknowledge bit check routine, which may be considered part of the state machine 50, will reset the acknowledge bit 44A of the processor 4₁, 4₂ . . . 4ₙ on which it is currently running, if that bit is found to be set. Prior to resetting a processor's acknowledge bit 44A, the acknowledge bit check routine will execute an SMP memory barrier instruction. This memory barrier ensures that all subsequent memory access on other processors 4₁, 4₂ . . . 4ₙ will perceive the acknowledge bit as having been reset on this processor from a memory-ordering point of view.

By resetting all of the acknowledge bits 44A, it will be implicitly guaranteed that each processor 4₁, 4₂ . . . 4ₙ will use the new grace period number 30 during any subsequent attempt by the registration component 36 to set the counter selector 46. This is because the acknowledge bits 44A will not be reset until there is an invocation of the state machine 50 that is subsequent to the invocation that resulted in the acknowledge bits 44A being set (and the grace period number 30 being incremented). If the state machine 50 runs in interrupt context, this result will be assured if the registration component 36 disables interrupts while executing (which it may do in order to avoid being interrupted by the state machine). Insofar as the state machine 50 will not run with interrupts disabled, the fact that it is running (at the time an acknowledge bit 14A is reset) signifies that all earlier invocations of the registration component 36 on the same processor 4₁, 4₂ . . . 4ₙ will have completed. The state machine 50 may thus unconditionally acknowledge the new grace period by resetting the acknowledge bit 14A of that processor. After all of the acknowledge bits 14A are reset on each processor 4₁, 4₂ . . . 4ₙ, and due to the memory ordering enforced by its memory barriers (as described above), the state machine 50 can guarantee that all processors 4₁, 4₂ . . . 4ₙ will have seen the new grace period number 30 (i.e., the counter “flip”). No new memory accesses by the registration component 36 on any processor will have preceded the resetting of the acknowledgement bits 14A. New invocations of the registration component 36 will therefore increment the next counter 42A rather than the current counter 42B, as is desirable. Thus, there is no need for the registration component 36 to perform a check to determine that it incremented the correct counter 42A or 42B, and if not, performing a second counter incrementation of the other counter.

With respect to old invocations of the registration component 36 that may have commenced prior to the incrementation of the grace period number 30, there will be no possibility of the grace period detection component 26 processing callbacks before the registration component has a chance to perform a counter incrementation (e.g., due to the registration component being delayed). Again, callback processing will not occur until the acknowledge bits 44A are all reset, thus ensuring that any previous invocation of the registration component 36 will have completed.

Instead of having the registration component 36 disable interrupts to prevent it from being interrupted by the state machine 50, which is expensive from a system performance standpoint, it would be possible to disable preemption instead. The state machine 50 may then check to see if preemption has been disabled as part of the wait_for_ack state 56, and if so, exit. A disadvantage of this approach is that an indefinite grace period delay could result if the state machine 50 was repeatedly invoked while preemption was disabled.

As another example of the preempt-disable approach, the state machine 50 could check to see if preemption has been disabled as part of the wait_for_ack state 56. If it has, the state machine 50 could set a per-task bit (e.g., “current->rcu_need_flip”) that is stored as part of the interrupted reader's task structure. The current->rcu_need_flip bit can be sampled by the registration component 36 when it restores preemption prior to exiting. If current->rcu_need_flip is set, the registration component 36 could reset it, then disable interrupts and invoke the state machine 50.

As a further variation of the preempt-disable approach, the registration component 36 could increment a per-task counter (e.g., “current->rcu_read_lock_enter”) stored as part of a reader's task structure to signify that the registration component has been invoked. The state machine 50 could then maintain two per-processor variables, one (e.g., “last_rcu_read_lock_enter”) that tracks rcu_read_lock_enter counter values, and the other (e.g., “last_rcu_read_lock_task”) that identifies the last reader to increment its rcu_read_lock_enter counter. If the state machine 50 interrupts the registration component 36 while preemption is disabled, it sets the last_rcu_read_lock_enter variable to current->rcu_read_lock_enter and last_rcu_read_lock_task to current (i.e., the reader 21₁, 21₂ . . . 21ₙ that called the registration component). The state machine 50 could also set a flag (e.g., “rcu_flip_seen_wait”) indicating that it was deferred, and then exit. When the next invocation of the state machine 50 sees the rcu_flip_seen_wait flag is set, it compares last_rcu_read_lock_enter to current->rcu_read_lock_enter, and compares last_rcu_read_lock_task to current. If either differ, the state machine 50 knows that any previously interrupted registration component 36 has completed. One disadvantage of this approach is that there may be “false positives” insofar as preemption is often disabled when the registration component 36 is not executing. As an alternative to the foregoing, instead of the state machine 50 sensing whether preemption is disabled, the registration component 36 could increment two per-task counters, one (e.g., “current->rcu_read_lock_enter”) upon entry and the other (e.g., “current->rcu_read_lock_exit”) upon exit. The state machine 50 may then compare the value of current->rcu_read_lock_entry to current->rcu_read_lock_exit, and reset the acknowledge bit 14A only if the two values differ, indicating that the state machine has interrupted the registration component.

After the acknowledge bits 14A have been reset for all processors 4₁, 4₂ . . . 4ₙ, the state machine 50 will next enter a wait_for_zero state 58 in which the grace period detection component 26 waits for the current counters 42B of all processors 4₁, 4₂ . . . 4ₙ to sum to zero. As indicated above, this means that all readers 21₁, 21₂ . . . 21ₙ have deregistered from the RCU subsystem 20 and that the callbacks on the Current Generation callback queue 32B are ready for processing by the callback processor 24. However, before leaving the wait_for_zero state 58, the grace period detection component sets the need-memory-barrier bit 44B for all of the processors 4₁, 4₂ . . . 4ₙ.

The state machine 50 next enters a wait_for_mb state 60 in which the grace period detection component 26 waits for all of the processors 4₁, 4₂ . . . 4ₙ to reset their need-memory-barrier bit 44B. The need-memory-barrier bits 44B of the processors 4₁, 4₂ . . . 4ₙ may be checked prior to invocation of the state machine 50 during handling of the same interrupt that causes the state machine to execute. In particular, a memory barrier shoot-down routine (which may be considered part of the state machine 50) is called that simulates synchronous memory barriers on all processors capable of executing the readers 21₁, 21₂ . . . 21ₙ (i.e., all of the processors 4₁, 4₂ . . . 4ₙ). This will result in a shoot down of any decrement of the current counter 42B that may have been performed out-of-order on a processor 4₁, 4₂ . . . 4ₙ by the deregistration component 38 before a reader's critical section was completed. Thus, the need for costly memory barriers in the deregistration component 38 to prevent a reader's critical section from bleeding into subsequent code is eliminated.

When the memory barrier shoot-down routine is called on each processor 4₁, 4₂ . . . 4ₙ, it implements an SMP memory barrier instruction on that processor, then resets the need-memory-barrier-bit 44B. This memory barrier ensures that all subsequent code on other processors 4₁, 4₂ . . . 4ₙ will, from a memory-ordering point of view, perceive all memory accesses that the memory barrier-implementing processor performed before executing the memory barrier (including reader critical section memory references and counter manipulations by the deregistration component 38). By implementing the memory barriers, it will thus be implicitly guaranteed that each reader 21₁, 21₂ . . . 21ₙ running on a processor 4₁, 4₂ . . . 4ₙ will have completed its critical section before the current grace period ends. By resetting its need-memory-barrier bit 44B, a processor 4₁, 4₂ . . . 4ₙ is advising the grace period detection component 26 that the memory barrier has been implemented. The state machine 50 will then resume the idle state 52.

The callback processor 24 may be called periodically to process all callbacks on the Current Generation callback queue 32B, thereby dispatching all callbacks associated with the current grace period generation. However, unlike prior read-copy update implementations, the callbacks may be advanced from the Next Generation callback queue 32A to the Current Generation callback queue 32B every two grace periods instead of every single grace period. This allows the registration component 36 to be simplified by eliminating costly memory barriers in the registration component 36 that prevent a reader's critical section from bleeding out into previous code. By waiting an extra grace period before processing callbacks, critical section data references performed prior to the registration component's counter incrementation will be protected. Even if the registration component 36 increments the wrong counter, the reader 21₁, 21₂ . . . 21 is protected because there will be no callback processing until all counters associated two consecutive grace periods have zeroed out.

As an alternative to processing callbacks every second grace period, an additional callback queue (not shown) could be used. This third callback queue would receive callbacks from the Next Generation callback queue 32A and hold them for one grace period before transferring the callbacks to the Current Generation callback queue 32B for processing.

Accordingly, a technique for realtime-safe read-copy update processing has been disclosed that reduces read-side overhead while maintaining memory ordering with grace period detection operations. It will be appreciated that the foregoing concepts may be variously embodied in any of a data processing system, a machine implemented method, and a computer program product in which programming logic is provided by one or more machine-useable media for use in controlling a data processing system to perform the required functions. Exemplary machine-useable media for providing such programming logic are shown by reference numeral 100 in FIG. 9. The media 100 are shown as being portable optical storage disks of the type that are conventionally used for commercial software sales, such as compact disk-read only memory (CD-ROM) disks, compact disk-read/write (CD-R/W) disks, and digital versatile disks (DVDs). Such media can store the programming logic of the invention, either alone or in conjunction with another software product that incorporates the required functionality. The programming logic could also be provided by portable magnetic media (such as floppy disks, flash memory sticks, etc.), or magnetic media combined with drive systems (e.g. disk drives), or media incorporated in data processing platforms, such as random access memory (RAM), read-only memory (ROM) or other semiconductor or solid state memory. More broadly, the media could comprise any electronic, magnetic, optical, electromagnetic, infrared, semiconductor system or apparatus or device, transmission or propagation medium (such as a network), or other entity that can contain, store, communicate, propagate or transport the programming logic for use by or in connection with a data processing system, computer or other instruction execution system, apparatus or device.

While various embodiments of the invention have been described, it should be apparent that many variations and alternative embodiments could be implemented in accordance with the invention. It is understood, therefore, that the invention is not to be in any way limited except in accordance with the spirit of the appended claims and their equivalents.

What is claimed is:

1. A method for realtime-safe detection of a grace period for deferring the destruction of a shared data element until pre-existing references to the data element are removed, comprising:
providing a grace period identifier for readers of said shared data element to consult;
initiating a next grace period by manipulating said grace period identifier; and
requesting acknowledgement of said next grace period from processing entities capable of executing said readers before detecting when a current grace period has ended.

2. A method in accordance with claim 1 further comprising:
arranging a memory barrier shoot-down on said processing entities; and
deferring data destruction operations to destroy said shared data element until it is determined that said memory barriers have been implemented.

3. A method in accordance with claim 1 wherein said grace period acknowledgement is requested by setting grace period acknowledgement flags associated with said processing entities, and wherein said grace period commencement acknowledgement is determined to be received based on said grace period acknowledgement flags being cleared.

4. A method in accordance with claim 2 wherein said memory barrier shoot-down is arranged by setting memory barrier request flags associated with said processing entities, and wherein said memory barriers are determined to be implemented based on said memory barrier request flags being cleared.

5. A method in accordance with claim 1 further including deferring data destruction operations to destroy said shared data element until two grace periods have expired.

6. A method in accordance with claim 2 wherein said data destruction operations to destroy said shared data element are further deferred until two grace periods have expired.

7. A method in accordance with claim 1 wherein said readers operate while disabling preemption but without disabling interrupts and wherein grace period detection operations run in interrupt mode but refrain from determining whether said requested acknowledgement has been received if said interrupt mode is due to an interruption of one of said readers.

8. A data processing system having one or more processors, a memory and a communication pathway between the one or more processors and the memory, said system being adapted to implement realtime-safe detection of a grace period for deferring the destruction of a shared data element until pre-existing references to the data element are removed, and comprising:
a grace period detection component adapted to:
provide a grace period identifier for readers of said shared data element to consult;
initiate a next grace period by manipulating said grace period identifier; and
request acknowledgement of said next grace period from processing entities capable of executing said readers before detecting when a current grace period has ended.

9. A system in accordance with claim 8 wherein said grace period detection system is further adapted to:
arrange a memory barrier shoot-down on said processing entities; and
defer data destruction operations to destroy said shared data element until it is determined that said memory barriers have been implemented.

10. A system in accordance with claim 8 wherein said grace period acknowledgement is requested by setting grace period acknowledgement flags associated with said processing entities, and wherein said grace period commencement acknowledgement is determined to be received based on said grace period acknowledgement flags being cleared.

11. A system in accordance with claim 9 wherein said memory barrier shoot-down is arranged by setting memory barrier request flags associated with said processing entities, and wherein said memory barriers are determined to be implemented based on said memory barrier request flags being cleared.

12. A system in accordance with claim 8 wherein said system is further adapted to defer data destruction operations to destroy said shared data element until two grace periods have expired.

13. A system in accordance with claim 9 wherein said system is further adapted to further defer said data destruction operations until two grace periods have expired.

14. A computer program product for realtime-safe grace detection of a grace period for deferring the destruction of a shared data element until pre-existing references to the data element are removed, comprising:
one or more machine-useable media;
logic provided by said one or more media for programming a data processing platform to operate as by:
providing a grace period identifier for readers of said shared data element to consult;
initiating a next grace period by manipulating said grace period identifier; and
requesting acknowledgement of said next grace period from processing entities capable of executing said readers before detecting when a current grace period has ended.

15. A computer program product in accordance with claim 14 wherein said logic is further adapted to program a data processing platform to operate as by:
arranging a memory barrier shoot-down on said processing entities; and
deferring data destruction operations to destroy said shared data element until it is determined that said memory barriers have been implemented.

16. A computer program product in accordance with claim 14 wherein said grace period acknowledgement is requested by setting grace period acknowledgement flags associated with said processing entities, and wherein said grace period commencement acknowledgement is determined to be received based on said grace period acknowledgement flags being cleared.

17. A computer program product in accordance with claim 15 wherein said memory barrier shoot-down is arranged by setting memory barrier request flags associated with said processing entities, and wherein said memory barriers are determined to be implemented based on said memory barrier request flags being cleared.

18. A computer program product in accordance with claim 14 wherein said logic is further adapted to program a data processing platform to operate as by deferring data destruction operations to destroy said shared data element until two grace periods have expired.

19. A computer program product in accordance with claim 15 wherein said data destruction operations to destroy said shared data element are further deferred until two grace periods have expired.

20. A computer program product in accordance with claim 14 wherein said program logic is further adapted to program a data processing platform to operate as by:
causing said readers to operate while disabling preemption but without disabling interrupts and causing grace period detection operations to run in interrupt mode but refrain from determining whether said requested acknowledgement has been received if said interrupt mode is due to an interruption of one of said readers.
